(19) United States
(12) Patent Application Publication
(10) Pub. No.: US 2016/0217490 A1
(43) Pub. Date: Jul. 28, 2016

(54) Automatic Computation of Keyword Bids For Pay-Per-Click Advertising Campaigns and Methods and Systems Incorporating The Same

(71) Applicant: Dealer Dot Com, Inc., Burlington, VT (US)

(72) Inventors: Hassan Malik, Monmouth Junction, NJ (US); Siming Sun, Edison, NJ (US)

(21) Appl. No.: 15/004,313

(22) Filed: Jan. 22, 2016

Related U.S. Application Data
(60) Provisional application No. 62/106,257, filed on Jan. 22, 2015.

(51) Int. Cl. G06Q 30/02; G06N 99/00

(52) U.S. Cl. CPC G06Q 30/0247; G06N 99/005

(57) ABSTRACT

Systems and methods for utilizing machine learning technology to automatically calculate optimal maximum bids for a set of pay-per-click (PPC) keywords associated with an advertising campaign are disclosed. Embodiments include techniques for obtaining high quality training data for training machine learning models, including obtaining high quality training data despite scarcity of data for a particular campaign. Embodiments may also include PPC management systems that may be configured to manage a plurality of PPC advertising campaigns and include one or more bid calculation engines that utilize performance data from the various advertising campaigns and machine learning algorithms to automatically determine optimal base bid values and bid multipliers for each of the advertising campaigns.

### RELATED APPLICATION DATA

This application claims the benefit of priority of U.S. Provisional Patent Application Ser. No. 62/106,257, filed Jan. 22, 2015, and title “Automatic Computation of Keyword Bids For Pay-Per-Click Advertising Campaigns and Methods and Systems Incorporating The Same,” which is incorporated by reference herein in its entirety.

### FIELD OF THE INVENTION

The present invention generally relates to the field of pay-per-click advertising. In particular, the present invention is directed to automatic computation of keyword bids for pay-per-click advertising campaigns and methods and systems incorporating the same.

### BACKGROUND

Pay-Per-Click (PPC) advertising on common search engines (such as Google® and Bing®) continues to be an important mechanism for obtaining quality traffic for business websites. These advertising campaigns typically consist of a set of keywords, with a maximum bid associated with each keyword. The maximum bid represents the maximum amount an advertiser is willing to pay for each click that results in a visit to the advertiser's website. Search engines typically provide online tools for advertisers to specify how much they are willing to bid for a given keyword and the search engines then hold automated auctions among the various advertisers every time a search for a keyword occurs.

Search keywords vary greatly in terms of their performance, and performance of the same keyword may differ significantly under different conditions. For example, a keyword that performs well on a holiday weekend in a given city may not perform well at a different time of the year in the same city. Also, advertising campaigns may have a large number of keywords and may also have a limited amount of data for determining which keywords will be the most successful and should therefore receive higher bids. Various PPC bid management tools and services have been developed for managing PPC bids, however, existing systems provide sub-optimal performance due, in part, to the complexities associated with choosing an optimal bid amount and scarcity of data, resulting in keywords being undervalued and having too low of a maximum bid or overvalued and having too high of a maximum bid.

### SUMMARY OF THE DISCLOSURE

In one implementation, the present disclosure is directed to a computer-implemented method for training a machine learning algorithm to predict a future value of an online advertising search engine pay-per-click (PPC) keyword for a local advertising campaign. The method includes continuously receiving PPC keyword performance data for the local advertising campaign as well as PPC keyword performance data for other advertising campaigns; creating, using a computer processor, a local data model based on PPC visitors to the local advertising campaign; creating, using a computer processor, a new training instance for the local data model for each local campaign PPC visitor, creating, using a computer processor, a global data model based on global data model PPC visitors, the global data model PPC visitors being PPC visitors to the local advertising campaign, as well as a selected subset of PPC visitors to the other advertising campaigns where the PPC visitor's visit has a characteristic in common with the local advertising campaign; creating, using a computer processor, a new training instance for the global data model for each global data model PPC visitor; training, using a computer processor, a machine learning algorithm with the local data model and global data model training instances to predict a future performance of a local advertising campaign PPC keyword.

In another implementation, the present disclosure is directed to a bid calculation system for determining pay-per-click (PPC) keyword bids for a plurality of advertising campaigns, including a keyword database for storing all PPC keywords for all of the plurality of advertising campaigns; a performance database for storing PPC keyword performance data for all of the plurality of advertising campaigns; and a keyword bid calculation engine including a non-transitory computer-readable medium with instructions stored thereon, that when executed by a processor, perform the steps including: creating local campaign model training instances for each of the plurality of campaigns based on PPC keyword performance data associated with PPC visitors to the corresponding respective local campaign; creating global model training instances for each of the plurality of campaigns based on PPC keyword performance data associated with PPC visitors to the corresponding respective advertising campaign, as well as a selected subset of PPC visitors to other ones of the plurality of advertising campaigns where the PPC visitor's visit has a characteristic in common with the local advertising campaign; computing a local classifier for each local campaign with the local model training instances; computing at least one global classifier for each local campaign with the global model training instances; and computing a base bid for each keyword for each local campaign with the local and global classifiers.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a diagram of an exemplary PPC keyword management system;

FIG. 2 shows exemplary configuration data for use in keyword bid management systems;

FIG. 3 is a diagram of an exemplary keyword bid calculation engine;

FIG. 4 is a flow diagram of an exemplary keyword bid calculation process;

FIG. 5 is a flow diagram of an exemplary train local data model sub-process of the process of FIG. 4;

FIG. 6 are flow diagrams for exemplary train global data model sub-processes of the process of FIG. 4;

FIG. 7 is a diagram of exemplary global data models;

FIG. 8 is a flow diagram of an exemplary create training instances sub-process of one or more of the processes of FIGS. 5 and 6;

FIG. 9 is a flow diagram of an exemplary compute bid sub-process of the process of FIG. 4;

FIG. 10 is a flow diagram of an exemplary compute bid multiplier sub-process of the process of FIG. 9; and

FIG. 11 is a block diagram of a computing system that can be used to implement one or more of the methodologies disclosed herein.

### DETAILED DESCRIPTION

Aspects of the present disclosure are directed to systems and methods for utilizing machine learning technologies to automatically calculate optimal maximum bids for a set of pay-per-click (PPC) keywords associated with an advertising campaign. Aspects also include techniques for obtaining high quality training data for training machine learning models, including obtaining high quality training data despite scarcity of data for a particular campaign. Aspects may also include PPC management systems that may be configured to manage a plurality of PPC advertising campaigns and include one or more bid calculation engines that utilize performance data from the various advertising campaigns and machine learning algorithms to automatically determine optimal base bid values and bid multipliers for each of the advertising campaigns.

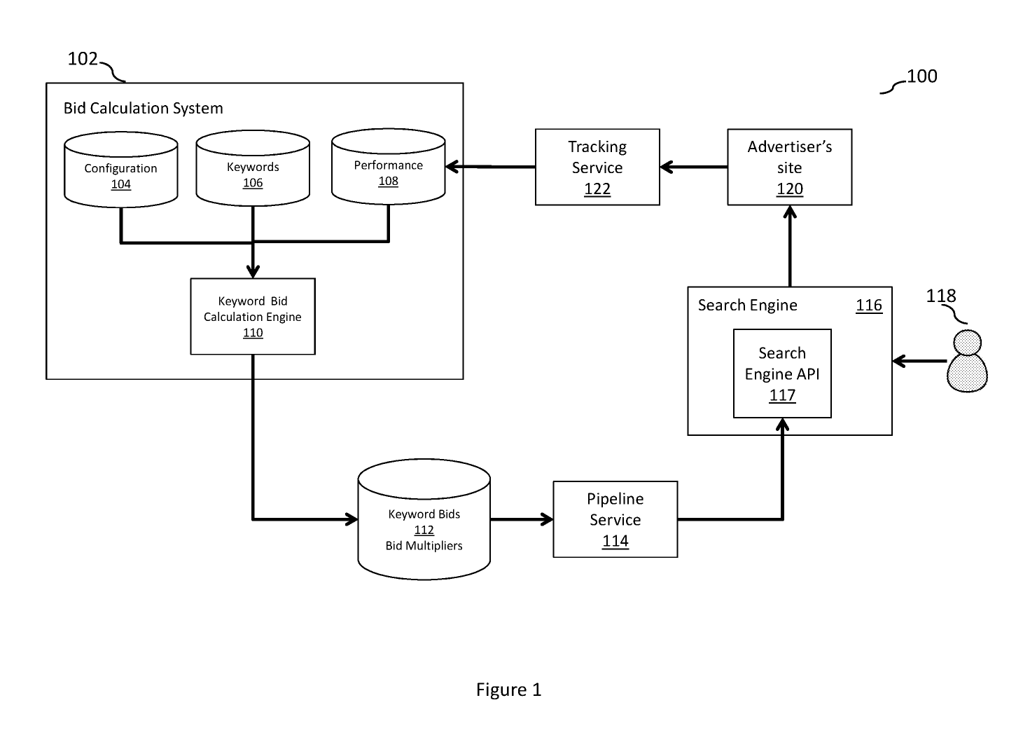

FIG. 1 illustrates an exemplary PPC bid management system 100 for automatically managing PPC bids for one or more advertising campaigns. As shown, system 100 may include a keyword bid calculation system 102 that, as described more below, utilizes machine learning algorithms for utilizing performance data to continuously learn how to determine an optimal bid value for a given campaign keyword based on system parameters and performance data. In the illustrated example, bid calculation system 102 may include a configuration database 104 that stores configuration information for each advertising campaign. As described more below, the configuration database may store various inputs and parameters for each advertising campaign that may be utilized by the calculation system algorithms to calculate a maximum bid. Bid calculation system 102 may also include a keyword text database 106 for storing all keywords for all campaigns and a performance database 108 for storing performance data associated with the performance of the campaign keywords. As shown, bid calculation system 102 may also include a keyword bid calculation engine 110 which may include one or more servers that are designed and configured to receive data from databases 104-108 and execute various machine learning algorithms for learning from the keyword bid performance data and to calculate optimized maximum bids. Engine 110 may also be configured to calculate one or more keyword bid multipliers, which may be applied to a base keyword bid under certain scenarios, such as specific day of the week, time, location, etc. of a particular search. System 100 may also include keyword bid and bid multiplier database 112 for storing the base bids and bid multipliers calculated by bid calculation system 102 and the system may include pipeline service 114 for receiving the bid calculations and transmitting them to search engines 116. In one example, pipeline service 114 may include one or more servers for pushing the bid and keyword data from bid database 112 to search engines 116 and one or more servers configured to communicate with search engine application programming interfaces (APIs) 117 for communicating the keyword and bid information.

Upon receipt of a search request from user 118, search engine 116 may automatically perform an auction among various advertisers having PPC keywords that are the same or similar to the user's search request. If user 118's search includes one or more keywords that are the same or similar to one or more keywords provided by pipeline service 114 to search engine 116, if the bid associated with that keyword wins the auction resulting in the inclusion of a sponsored link or advertisement in the user's search results, and if the user clicks on the sponsored link, the user will be sent to advertiser's site 120 of the advertiser having the ad campaign that won the PPC keyword auction. Tracking service 122 may then collect various information associated with the user and the user's visit to advertiser's site. Any of a variety of tracking services and tracking techniques known in the art may be used. As will be appreciated, one or more of tracking service 122 and search engine 116 may provide a variety of tracking data associated with user 118's visit to advertiser's site. As a non-limiting example, the tracking information may include a unique visitor ID associated with the user, the user's geographic location, the type of device the user used to access the site, the time and day of the search, the pages the user visited on the advertiser's site, the length of time spent on the site, and the actions the user took on the site. The user's actions that may be tracked and recorded may include conversion information indicating whether the visitor was successfully converted from just visiting the site to taking a further action. As will be appreciated, conversion may be domain-dependent and may also be advertiser-dependent, depending on the goals and objectives common to a domain and/or the goals of a given advertiser. For non-limiting example, a successful conversion for a visit to an electronics manufacturer's website may be the purchase of a product. A conversion for a travel website may be booking a flight or reserving a hotel room or rental car. A conversion on a site advertising higher-priced products such as automobiles may be the generation of a lead through the completion of an online form by the visitor or extended and/or repeat site visits by the same unique visitor to obtain information about a specific type of automobile. The tracking data may also be configured to identify user 118 when he or she makes a return visit to site 116, such that bid calculation system 102 may associate a visitor's future action on site 116 with a keyword previously purchased. Any of a variety of tracking services and techniques may be used, including, for example, utilizing 1×1 tracking pixels and cookies. As described more fully below, bid calculation system 102 may receive the tracking information from tracking service 122 and/or search engine 116 and store the information in performance database 108 for use as features for training instances utilized by machine learning algorithms to determine optimal bid values.

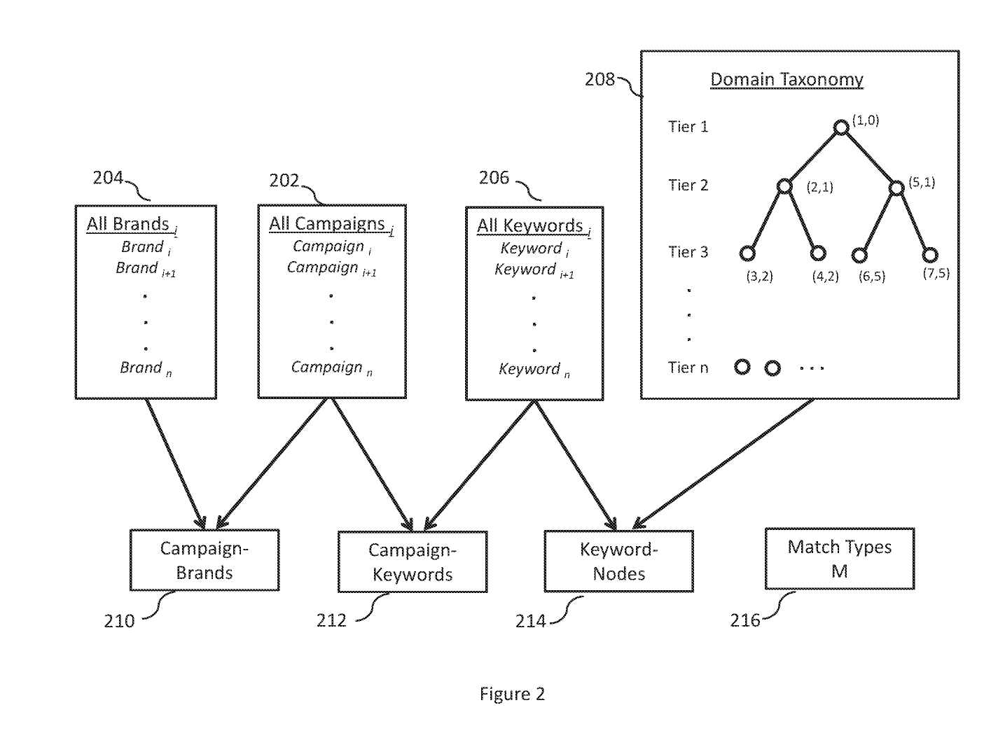

FIG. 2 illustrates examples of configuration data structures 200 that may be included in configuration database 104 for use with bid calculation engine 110 (FIG. 1). In the illustrated example, the configuration data may include information for a plurality of advertising campaigns and may include an All Campaigns list 202 which may include a listing of all advertising campaigns managed by the system. In one example, a unique advertiser may have one or more advertising campaigns with associated keywords requiring bid calculation and management. The configuration data may also include a variety of other information about each advertiser. For example, it could include location information for the unique advertiser (not illustrated) such as geographic location of one or more locations of the advertiser as well as advertiser website addresses. The configuration data may also include an advertiser's target market area(s), among other information. The advertisers may include a large number of advertisers located across a geographic region and/or across one or more countries that may be selling products in the same domain, such as electronics or automobiles. As described below, the present disclosure includes powerful machine learning algorithms that may leverage configuration and performance data from the various advertisers to determine optimized bid values for a specific campaign. In the illustrated example, the configuration data may also include All Brands list 204, which may be a listing of all brands sold by the various ad campaigns being managed by the system. The configuration information may also include All Keywords list 206, which may be a listing of all keywords for all of the advertising campaigns being managed. In one example, each entry in All Keywords list 206 may be a full phrase or combination of words, such as “plasma TV” or “cheap cars,” etc. As will be appreciated, any one of a variety of techniques may be used for generating the keywords for a particular ad campaign, including utilizing various automated tools for generating suggested keywords based on, for example, empirical data.

Configuration data 200 may also include a domain-specific taxonomy that, in the illustrated example, is a hierarchical structure for categorizing products within a given domain. For example, if a bid management system included one or more advertising campaigns for electronics, a domain taxonomy may include first tier categories such as televisions, computers, etc., and a second tier category for televisions may include a television size, or television type (e.g., flat screen or projection), and further categories may include screen type (e.g., LCD, LED, OLED, etc.), or other features (HDMI inputs, USB ports, etc.). If a bid management system included one or more advertising campaigns for another domain, a different domain taxonomy may be employed. For example, if one or more advertising campaigns were for automobiles, the tier levels may include categories such as vehicle category (e.g., SUV, sedan), make, model, trim, accessories, engine type, etc. As shown in FIG. 2, the domain taxonomy may be described as a hierarchical network of nodes, with each node having a unique id and each node may also have parent node id information.

As shown in FIG. 2, configuration data 200 may also include data structures for cross referencing or linking one or more of the brand, campaign, keyword, and taxonomy information for specifying the information associated with a given campaign and for utilizing performance data from a plurality of campaigns for calculating optimal bids for a specific campaign. In the illustrated example, the data 200 may include a Campaign-Brands 210 data structure, which may include, for each campaign in All Campaigns list 202, a list of every brand in All Brands list 204 that is associated with a given campaign. Campaign-Keywords 212 may include, for each campaign in All Campaigns list 202, a list of each keyword in All Keywords list 206 associated a given campaign. And Keyword-Nodes 214 may be a list linking each keyword in All Keywords list 206 to unique node ids and associated parent node ids in domain taxonomy 208. For example, for a keyword including “V6 Cherokee,” keyword nodes 214 may associate a node id for engine type and a node id for model from domain taxonomy 208 with the keyword in keyword-nodes 214. Configuration data 200 may also include match type information, which defines the set of match types that may be considered by the bid calculation engine. For example, a maximum bid for a given keyword may vary depending on whether the user's search terms included an exact match to the keyword or something less than exact that is somewhat related to the keyword. For non-limiting example, the set of match types 216 may be any set of match types known in the art or considered by a search engine, including match types such as broad match, broad match modifier, phrase match, exact match, and negative match.

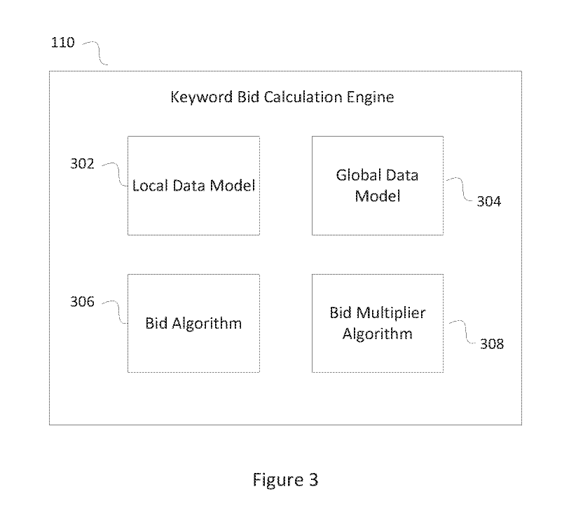

FIG. 3 illustrates an example of functionality that may be included in keyword bid calculation engine 110 (also illustrated in FIG. 1). As described above, calculation engine 110 may be configured to execute one or more machine learning algorithms which may include one or more models that may utilize training instances to predict future PPC keyword performance and thus determine an optimal bid for the keyword. As used herein, machine learning broadly refers to utilizing algorithms to learn from data. As will be appreciated, a variety of different types of machine learning techniques, including currently existing techniques as well as techniques developed in the future may be employed in embodiments of the present disclosure. Non-limiting examples of machine learning techniques that may be employed include decision tree and association rule learning, supervised, unsupervised, or semi-supervised learning, and classification, regression, and clustering techniques, among others. As described more fully below, an example implementation disclosed herein utilizes supervised binary classifier machine learning models and algorithms. In some examples, supervised learning models utilizing Support Vector Machines (SVM) may be used. As will be appreciated, the exemplary models are merely provided by way of example and other machine learning techniques may also be utilized to implement PPC bid management systems made in accordance with the present disclosure.

As shown in FIG. 3, an example of bid calculation engine 110 may include one or more local data models 302 that, as described more below, may be configured to learn from performance data associated with a specific campaign to train one or more local classifiers, and global data model 304 that, as described more below, may be configured to learn from performance data from not only a specific campaign for which a bid is to be calculated, but from a variety of other specifically selected campaigns that share keywords or brands with the target campaign, to train one or more global classifiers. Such an approach may result in high quality training instances that may be used for powerful machine learning predictions for a specific campaign even if there is limited performance data associated with the specific campaign. As used herein, the term “local,” e.g., the term local in each of local campaign, local data model, local classifier, local visitors, etc., does not have any geographic connotation or limitation. For example, a single “local” campaign could be targeted at any size geographic area, from a single town, to worldwide. Similarly, as used in the present application, “global” does not have any geographic connotation or limitation and refers to more than one campaign, e.g., more than one campaign in All Campaigns list 202. As described more below, in one example, a global data model may consider data from all campaigns that bid calculation system 102 has access to performance data for, e.g., all campaigns in All Campaigns list 202, and may use all or a subset of that data as training instances for predicting future PPC keyword performance.

Bid calculation engine 110 may also include one or more bid algorithms 306 for calculating a base bid based on the classifiers generated by models 302 and 304, and the engine may also include bid multiplier algorithm 308 for utilizing performance data to automatically calculate various bid multipliers. Thus, keyword bid calculation engine 110 may utilize machine learning models to generate classifiers that are continuously updated with information as new visitors visit a campaign website as a result of a keyword purchase, such that the classifiers are continuously modified to generate more and more accurate predictions of whether a specific keyword for a specific campaign will be associated with a successful conversion and should, therefore, receive a higher bid.

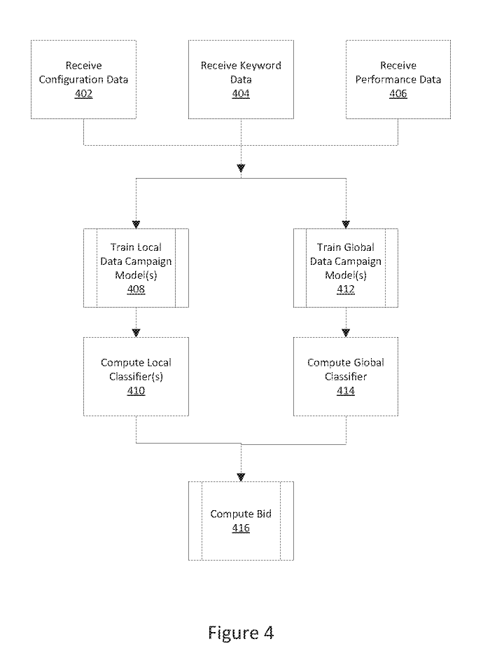

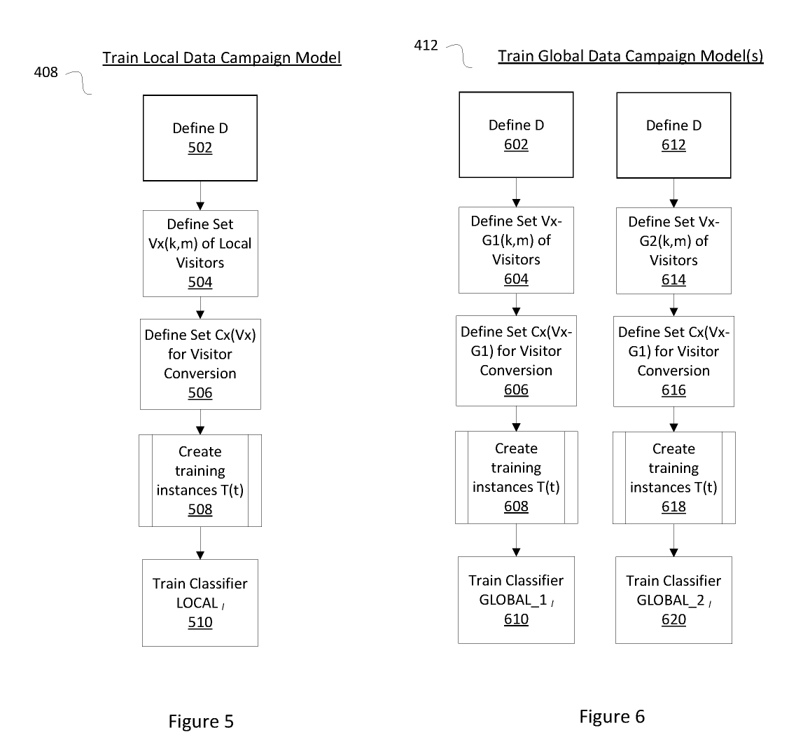

FIG. 4 illustrates exemplary functionality for a bid calculation engine made in accordance with the present disclosure. As shown, the functionality may include, at step 402, receiving configuration data, at step 404, receiving keyword data, and at step 406, receiving performance data. By way of example, the configuration data, keyword data, and performance data may be obtained from the configuration database 104, keywords database 106, and performance database 108, respectively (FIG. 1) and may include any of the data formats and characteristics described herein. At sub-process 408, the bid calculation engine may use the data to train one or more local data campaign models, which may be used at step 410 to compute one or more local classifiers. At sub-process 412 the bid calculation engine may also use the data to train one or more global data models, which may be used, at step 414, to compute one or more global classifiers, and at sub-process 416, the classifiers, performance data, configuration data, and keyword data may be used to calculate a bid, which may include calculating a base bid as well as bid multipliers. FIGS. 5 and 6 illustrate sub-processes 408 and 412 in greater detail. In the illustrated example shown in FIG. 5, sub-process 408 includes a single local data campaign model. In alternative embodiments, no strictly-local data models or more than one local-data models may be used. As shown, train local data campaign model sub-process 408 may include, at step 502, defining the number of days “D” from which performance data may be used to train the local data model. At step 504, a set Vx(k,m) of local visitors may be defined, wherein visitors Vx(k,m) may be a set of unique PPC visitors that have visited local campaign All Campaignᵢ within D days, where k represents the PPC keyword that was purchased for visitor Vx and m represents the match type associated with the PPC keyword purchase. Thus, in the illustrated example, the local data campaign model may be trained with training instances based on unique visits to the campaign website as a result of the visitor clicking on a sponsored link purchased by the campaign as a result of bidding on a campaign keyword k with match type m. In alternative embodiments, set Vx may not include information on match type m. At step 506, conversion set Cx(Vx) may be defined, where C may be a set of binary values where each Cx represents whether visitor Vx was converted within a pre-defined conversion window. As discussed above, the definition of conversion and the duration of the conversion window may be domain-dependent. In the illustrated example, set Cx may be updated as visitor Vx makes subsequent visits to a campaign website, such that, after initially receiving a visit from visitor Vx as a result of a PPC keyword purchase, if visitor Vx results in a conversion on a subsequent visit within the pre-defined conversion window, set Cx may be updated to reflect a positive conversion associated with Vx(k,m). For example, in the e-commerce domain, if a visitor does not purchase anything on a first visit, Cx may initially be false but if the visitor returns to the site within D days (i.e., the conversion window) and purchases a television, Cx may be updated to be true. At sub-process 508, training instances T(t) may be created for learning from performance data, and at step 10, T(t) may be used to train classifier LOCALᵢ. In one embodiment, classifier LOCAL_{i.} may be a binary classifier that uses all members of V that has a positive conversion entry in C as positive examples and the rest as negative examples. In other embodiments, classifier types other than binary classifiers may be used.

FIG. 6 illustrates exemplary sub-process 412 for training global data campaign models. In the illustrated example, a bid calculation engine may utilize two global data models. In other embodiments, none, one, or more than two models may be utilized. As shown, training of a first global data model may begin at step 602, where a number of days “D” may be defined over which performance data will be used for training the global data model. As will be appreciated, D may be varied for each model, such that, in one embodiment, D may be the same for all local and global models, while in other embodiments, D may be different for one or more models to obtain an optimal dataset for each model. The selection of D may be influence by a variety of factors. For example, D may be increased for models based on a lower amount of training data. At step 604, a set of visitors Vx-G1(k,m) may be defined. In one embodiment, set Vx-G1(k,m) may include all unique PPC visitors to local campaign All Campaignᵢ, as well as a selected subset of PPC visitors to one or more of the other campaigns in All Campaigns 202 (FIG. 2) that have a characteristic of interest for a local campaign. For example, Vx-G1(k,m) may include unique visitors to other campaign sites that visited as a result of a keyword associated with local campaign All Campaignᵢ. For example, unique visitors to other campaigns where the purchased keyword was the same or similar to one of the keywords in local campaign All Campaignᵢ. In other embodiments, Vx-G1(k,m) may include unique visitors to other campaign sites that sell one or more of the same brands as a brand sold by local campaign All Campaignᵢ. In yet other embodiments, Vx-G1(k,m) may include unique visitors to other campaign sites having some other characteristic in common with local campaign All Campaignᵢ, such as all other campaigns within the same geographic area or region as All Campaignᵢ, or all other campaigns focusing on a similar market segment as a market segment focused on by All Campaignᵢ, such as sports cars, luxury cars, family cars, high-end electronics, men over 40, woman with children, people under 30, etc. Thus, bid calculation engines made according to the present disclosure may be configured to learn from a larger dataset than just the performance data associated with a local campaign, while ensuring only high-quality training data is utilized. At sub-process 508, after defining the set of visitors, a set T(t) of training instances may be created and at step 610, the training instances may be used to train classifier GLOBAL_1ᵢ. As with LOCALᵢ, GLOBAL_1ᵢ may be a binary classifier, or in other embodiments, may be another type of classifier.

Steps 612 through 620 may be substantially the same as steps 602-610, with variations as appropriate for building a second global data campaign model. For example, set Vx-G2(k,m) may include visitors to local campaign site as well as other sites with characteristic in common with All Campaignᵢ that is different than set Vx-G1(k,m). Similarly, the set of training instances at sub-process 618 and training local classifier GLOBAL_2ᵢ may utilize the same machine learning techniques as sub-process 608 and step 610 or different techniques.

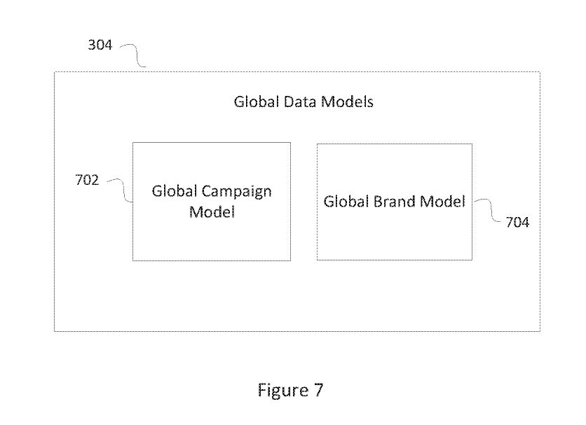

FIG. 7 illustrates an example of global data models 304 that may include two types of global data models including global campaign model 702 and global brand model 704. For ease of comparison, global campaign model 702 may be implemented according to steps 602 to 610 of FIG. 6 and global brand model 704 may be implemented according to steps 612 to 620 of FIG. 6. In one example, a global campaign model 702 may be utilized for a campaign and may be configured to include a set of visitors Vx-G1(k,m), where each visitor Vx is a unique visitor to local campaign All Campaignᵢ or is a unique PPC visitor to any campaign in All Campaigns 202 (FIG. 2) where the visit was the result of a purchased keyword that is also associated with the local campaign. Thus, global campaign model 702 may be configured to train on a larger dataset than just performance data associated with a local campaign, but also on a subset of performance data for any other campaign having the same keywords as the local campaign keywords. Such a model may be able to predict how a specific keyword will perform in a local campaign based on performance information associated with the keyword in other campaigns.

Global brand model 704 may be configured to include a set of visitors Vx-G2(k,m) (FIG. 6), where each visitor Vx is a unique visitor to local campaign All Campaignᵢ or is a unique PPC visitor to any campaign in All Campaigns 202 (FIG. 2) advertising one of the brands associated with the local campaign. In one example, a separate global data brand model for one or more of the brands may be utilized and a classifier for each brand may be trained with training instances for all visitors to all campaigns that advertise the given brand. The brand model classifiers may then be used to determine a bid for a specific keyword for a specific campaign by combining the brand models for the brands being sold by the local campaign All Campaignᵢ. In one example, the values of each binary classifier of the relevant brand models may be summed and divided by the number of relevant models to obtain a ratio between zero and 1 that may be combined with the results from other models to calculate a bid value. Thus, global brand model 704 may be configured to train on a larger dataset than just performance data associated with a local campaign, but also on a selected subset of performance data for any other campaign selling the same brands as the local campaign.

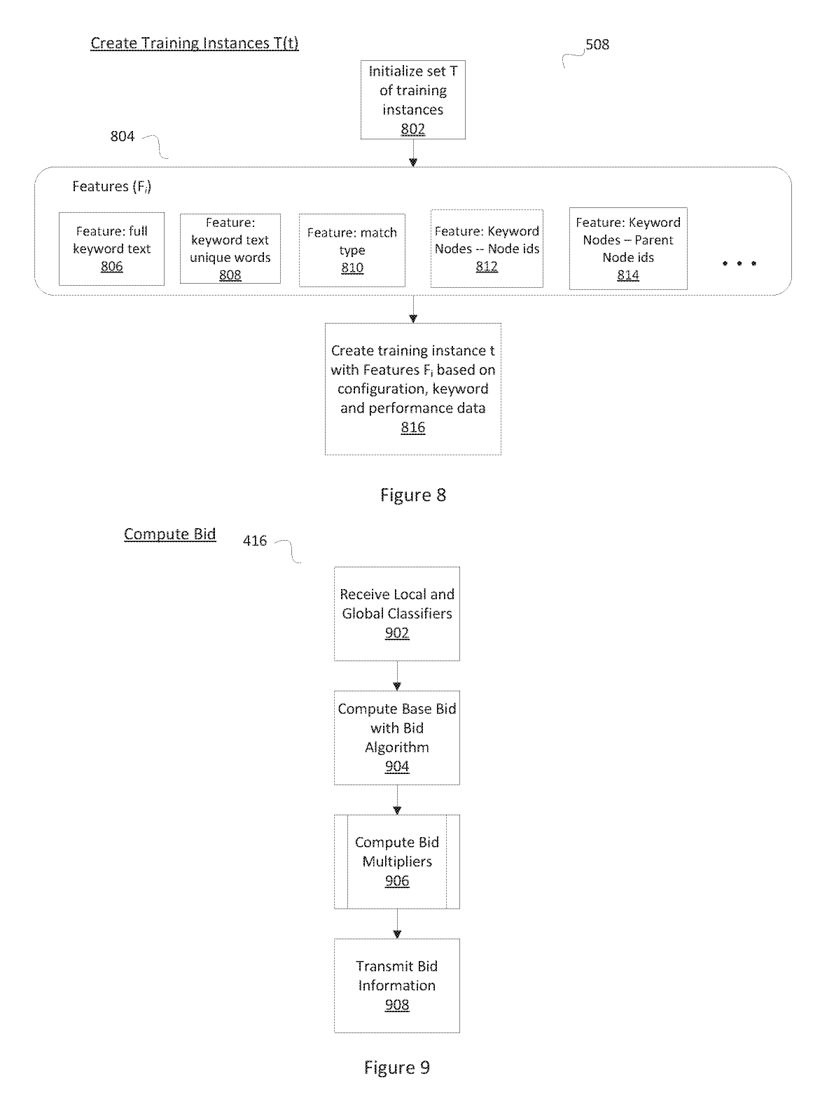

FIG. 8 illustrates an example of one or more of sub-processes 508, 608, and 618 (FIGS. 5 and 6) for creating training instances T(t). As shown in FIG. 8, to create training instances for training a machine learning model, the process may begin at step 802, where a set T of training instances may be initialized and then at step 804, for each unique visitor, a training instance t may be created with one or more features F. In the illustrated example, the features F may include one or more of a full keyword text feature 806 representing the full PPC keyword associated with the visitor, keyword text unique words features 808 which may include a feature for each unique word in the keyword (these unique words are optionally passed through a standard stemmer, the output of which becomes the feature), a match type feature 810 for the match type associated with the unique visitor-PPC keyword, keyword nodes—node id features 812, which may include a feature for each node id from domain taxonomy 208 (FIG. 2) that is associated with the keyword for the visitor Vx, and keyword node—parent nodes features 814, which may include a feature for each parent node id associated with the node ids for the keywords associated with visitor Vx. Such features may be used to obtain extremely powerful and high quality training data that may be used to calculate accurate bids for a specific campaign. For example, features 812 and 814 are configured to leverage domain taxonomy information to automatically gain valuable insight from a potentially vast amount of data across a large number of campaigns. As will be appreciated, the features illustrated in FIG. 8 are merely shown by way of example and other sets of features may be used. In addition, the set of feature types may vary among the various models utilized by a bid calculation engine made in accordance with the present disclosure. At step 816, a training instance t may be created for each visitor Vx with features 804. With the training instance created, as discussed above, a classifier for each model may be trained with the training instances (see steps 510, 610, and 620, FIGS. 5 and 6). In one embodiment, t may be added to T as a positive instance if Cx is true, meaning the visitor was converted (see, for example step 506 of FIG. 5 and associated discussion), and otherwise may be added as a negative instance, and T may be used to train a classifier, such as a binary classifier. Thus, keyword bid calculation engine 110 may create a training instance for each unique visitor Vx and the training instance may include a variety of information about the visitor, including whether the visitor was converted and the purchased keyword associated with the visitor. This information may then be applied to a machine learning algorithm, which may use the data to determine a probability that a desired outcome will occur in the future, which may be used to compute an optimal maximum bid. In the illustrated example, the training instances data may be applied to a binary classifier algorithm to train a binary classifier for a specific keyword for a specific campaign. As discussed below, the binary classifier for the one or more models may be used to calculate an actual maximum bid value for a given keyword for a given campaign.

FIG. 9 illustrates an example of compute bid sub-process 416 (FIG. 4) for calculating a base bid and bid multipliers. As shown, sub-process 416 may include, at step 902, receiving local and global classifiers trained by local data model(s) 302 and global data model(s) 304 (FIG. 3), such as classifiers LOCALᵢ, GLOBAL_1ᵢ, and GLOBAL_2ᵢ, (FIGS. 5 and 6). At step 904, the classifiers from the various models may be used as inputs to one or more algorithms for calculating a base bid for a specific keyword for a specific campaign. In one example, the following algorithms may be used:

Bid=S₁w₁+S₂w₂+S₃w₃ Eq. (1)

(Bidₘᵢₙ≦bid≦Bidₘₐₓ) Eq. (2)

wherein:

S₁ is a binary value set equal to 0 or 1 depending on the value of LOCALᵢ

S₂ is a binary value set equal to 0 or 1 depending on the value of GLOBAL_1ᵢ

S₃ is a binary value set equal to 0 or 1 depending on the value of GLOBAL_2ᵢ

w₁, w₂, w₃, Bidₘᵢₙ, and Bidₘₐₓ are user-defined parameters.

In another embodiment, where GLOBAL_2ᵢ is trained by global brand model 704, S₃ may be determined with the following equation:

S3=g/size (CAMPAIGN_BRANDSᵢ) Eq. (3)

wherein:
g may be determined by the following process:
   (1) Initialize g=0
   (2) For each brand b in CAMPAIGN_BRANDSᵢ, apply GLOBAL_2ᵢ and increment g by 1 if positive
      wherein:
CAMPAIGN_BRANDSᵢ is a list of brands associated with local campaign (see campaign brands 210 (FIG. 2).

Thus, a base bid “Bid” may be determined for a given keyword for a given campaign by leveraging models developed with machine learning techniques that learn from local campaign performance data as well as a selected subset of global data and training instances with specially-designed features that leverage cross referencing of common characteristics among a large number of campaigns. In the illustrated example, a set of training instances with features associated with unique visitors may be used to determine a probability for how a specific keyword may perform, represented by a binary classifier having a value of either 0 or 1. The value of the classifier may be continuously updated as additional training instances are entered, with the threshold between 0 and 1 being dependent on the algorithms utilized. In one example, the binary results for each model are multiplied by user-defined parameters and then summed to determine a bid value. A new bid value may then be communicated to a search engine, for example, the bid may be updated hourly, or daily.

In another example, separate global data models for each brand sold by any of the campaigns being managed may be developed and a binary classifier may be trained for each model (see, e.g., global brand model 704 (FIG. 7) and Equation (3), above). A bid value for a given keyword for a given campaign may be calculated by also including the results of the brand models for the brands associated with the specific campaign, as defined by campaign-brands 210 (FIG. 2). The results from the brand models may be included in a variety of ways, for example, utilizing Equation 3 (above) and then multiplying the result by a user-defined parameter.

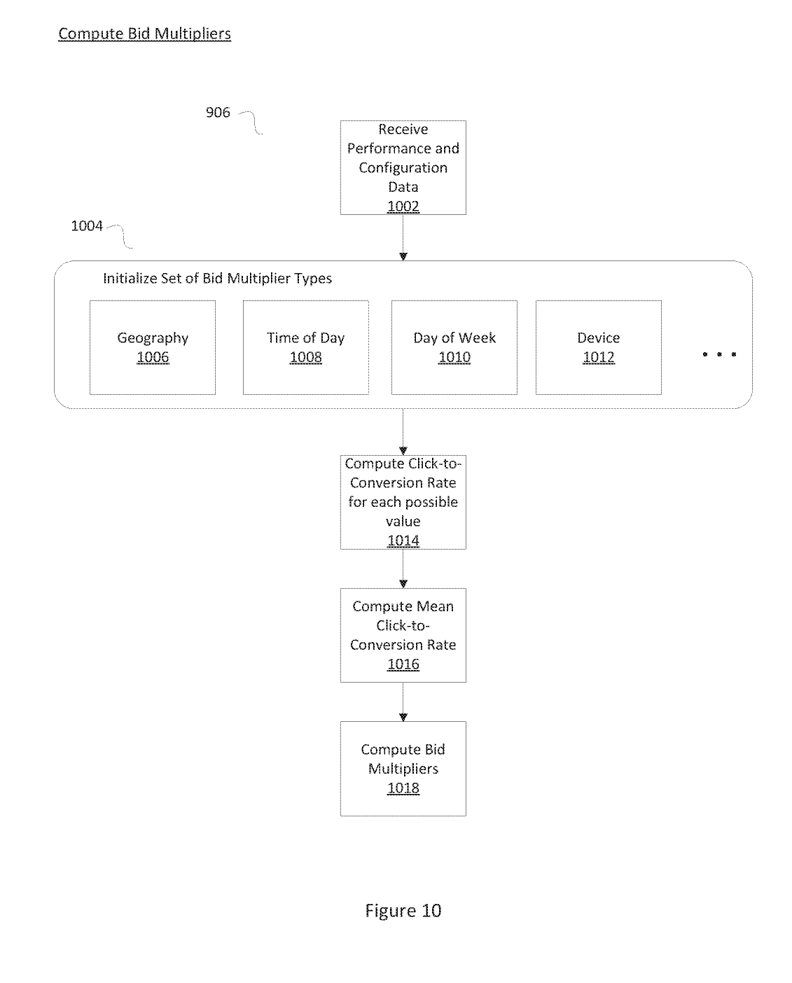

At sub-process 906, one or more bid multipliers may be automatically calculated with performance data and at step 908, the calculated bid information may be transmitted to a search engine via, for example, bid database 112 and pipeline service 114 (FIG. 1). FIG. 10 illustrates an example of sub-process 906, compute bid-multipliers. As described above, bid multipliers may be applied to a base bid for a particular keyword based on specific characteristics of a particular auction. For example, bids may be modified based on the time of day, day of week, the geographic location of the user requesting the search engine search, or the type of the device the user is using (e.g., desktop, phone, tablet, etc.). Thus, at step 1002, the bid multiplier sub process may receive performance and configuration data and at step 1004, a set of bid multipliers may be initialized, which may include one or more of geography modifiers 1006, time of day modifiers 1008, day of week modifiers 1010, device modifiers 1012, as well as any other modifier that may be based on the performance data available. At step 1014, for each multiplier, a click-to-conversion rate may be calculated for each possible value. For example, for geography modifiers 1006, a click-to-conversion rate may be calculated for every zip code, etc. In one example, separate bid multipliers are determined for each campaign, and local campaign data is used to calculate the modifier. Thus, if data is not available for a given value, the value is set to a pre-defined default value. Click to conversion rate may be obtained by a variety of different sources, including from tracking service 122, or search engine 116. In other embodiments, click to conversion rates may also be obtained from one or more other selected campaigns, which may improve the multipliers by being based on larger dataset. At step 1016, for each multiplier, a mean click-to-conversion rate may be calculated for a given multiplier type for a given campaign and at step 1018, bid multipliers may be calculated from the mean click-to-conversion rates using, for example any standard transformation method such as, for example, a z-score transformation.

In one embodiment, an example bid calculation engine made in accordance with the present invention may be configured according to the following:

Given:
Set ALL of advertising campaigns
Set BRANDS of brands
Set CAMPAIGN_BRANDS such that each member CAMPAIGN_BRANDSᵢ contains a list of brands that relate to the campaign ALLᵢ
Set KEYWORDS of keywords
Set M of match types
Domain-specific taxonomy T such that T contains a set of nodes N, where each member Nⱼ is represented by a pair (id, parent id) and parent id may be a null identifier if there is no parent
Set KEYWORD_NODES such that each member KEYWORD_NODESₖ contains a list of node ids in N that are mapped to KEYWORDSₖ
Set CAMPAIGN_KEYWORDS such that each member CAMPAIGN_KEYWORDS contains a list L of keywords that are allowed for the campaign ALLᵢ and each member of L is in KEYWORDS

To Train Local Campaign Models:

For each campaign ALLᵢ in ALL
1. Set V is a set of unique Pay-Per-Click visitors in the last D days (where D is configurable), each member Vₓ in V is a list of pairs (k, m) where k represents a PPC keyword that was bought for the x^{th} visitor and m represents its match type such that m is in M. The x^{th} visitor must directly belong to ALLᵢ.
2. Set C of binary values, where each value Cₓ represents whether the x^{th} visitor was converted (the definition of conversion is domain dependent)
3. Initialize a set T of training instances
4. For each member Vₓ in V
   (a) Create a training instance t with the following features
      A feature representing full keyword text
      A feature for each unique word in the keyword
      A feature for match type
      A feature for each node id in KEYWORD_NODESₖ that represents keyword k s entry in KEYWORD_NODES
      A feature for each parent node, added by processing each member in KEYWORD_NODESₖ and recursively find all of its parents from T
   (b) Add t to T as a positive instance if Cₓ is true. Otherwise add as a negative instance
5. Use T to train a binary classifier LOCALᵢ

To Train Local Campaign Models Using Global Data:

For each campaign ALLᵢ in ALL
1. Set V is a set of unique Pay-Per-Click visitors in the last D days (where D is configurable), each member Vₓ in V is a list of pairs (k, m) where k represents a PPC keyword that was bought for the x^{th} visitor and m represents it's match type such that m is in M. The x^{th} visitor must either directly belong to ALLᵢ OR any another member of ALL, if there exists keyword y, such that y was bought for x^{th} visitor and it's also in CAMPAIGN_KEYWORDSᵢ.
2. Set C of binary values, where each value Cₓ represents where the x^{th} visitor have converted (the definition of conversion is domain dependent)
3. Initialize a set T of training instances
4. For each member Vₓ in V
   (a) Create a training instance t with the following features
      A feature representing full keyword text
      A feature for each unique word in the keyword
      A feature for match type
      A feature for each node id in KEYWORD_NODESₖ that represents keyword k s entry in KEYWORD_NODES
      A feature for each parent node, added by processing each member in KEYWORD_NODESₖ and recursively find all of its parents from T
   (b) Add t to T as a positive instance if Cₓ is true. Otherwise add as a negative instance
5. Use T to train a binary classifier LGᵢ

To Train Brand Models:

For each brand b in BRAND
1. BC is a set of campaigns such that for each entry in BC, it's corresponding entry in CAMPAIGN_BRANDS contains b
2. Set V is a set of unique Pay-Per-Click visitors in the last D days (where D is configurable), each member Vₓ in V is a list of pairs (k, m) where k represents a PPC keyword that was bought for the x^{th} visitor and m represents it's match type such that m is in M. The x^{th} visitor must directly belong to a member of BC.
3. Set C of binary values, where each value Cₓ represents where the x^{th} visitor have converted (the definition of conversion is domain dependent)
4. Initialize a set T of training instances
5. For each member Vₓ in V
   (a) Create a training instance t with the following features
      A feature representing full keyword text
      A feature for each unique word in the keyword
      A feature for match type
      A feature for each node id in KEYWORD_NODESₖ that represents keyword k s entry in KEYWORD_NODES
      A feature for each parent node, added by processing each member in KEYWORD_NODESₖ and recursively find all of its parents from T
   (b) Add t to T as a positive instance if Cₓ is true. Otherwise add as a negative instance
6. Use T to train a binary classifier BRAND_{b}

To Compute Base Keyword Bids:

For each campaign ALLᵢ in ALL
1. For each keyword k in CAMPAIGN_KEYWORDSᵢ
   (a) For each match type m in M
      Apply LOCALᵢ and store the binary result (1 or 0) to S1
      Apply LGᵢ and store the binary result (1 or 0) to S2
      Initialize g=0
      For each brand b in CAMPAIGN_BRANDSᵢ
      (i) Apply BRAND_{b} and incement g by 1 if positive
      S3=g/size (CAMPAIGN_BRANDSᵢ)
      Bid=S₁w₁+S₂w₂+S₃w₃ (Bidₘᵢₙ>bid<=Bidₘₐₓ), where w1, w2, w3, Bidₘᵢₙ and Bidₘₐₓ are parameters

To Compute Bid Multipliers:

For each bid multiplier type (e.g., geography, time of the day, day of the week, device type)
1. For each possible value (e.g., in case of geography, values may be a list of zip codes in the campaign's target area)
   (a) Compute click-to-conversion rates
2. Compute mean click-to-conversion rates
3. For each dimension, compute a bid multiplier using any standard transformation method (e.g., z-score transformation)

Any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

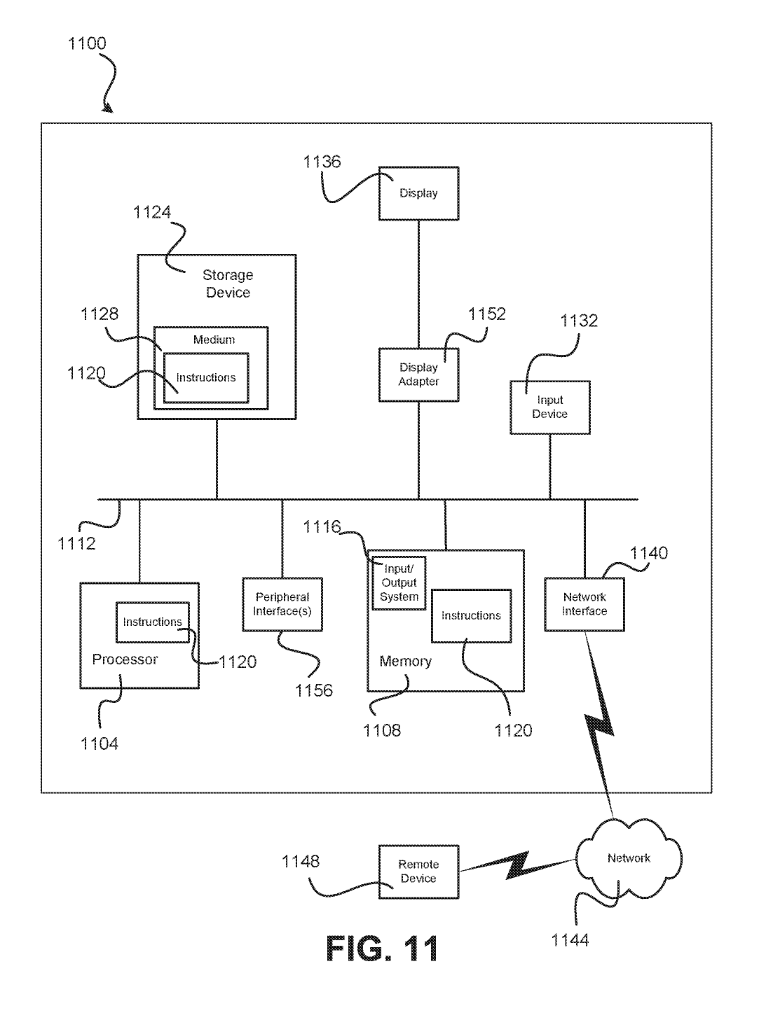

FIG. 11 shows a diagrammatic representation of one embodiment of a computing device in the exemplary form of a computer system 1100 within which a set of instructions for causing a control system, such as the PPC bid management system 100 of FIG. 1, to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1100 includes a processor 1104 and a memory 1108 that communicate with each other, and with other components, via a bus 1112. Bus 1112 may include any of several types of bus structures including, but not limited to, a memory bus, a memory controller, a peripheral bus, a local bus, and any combinations thereof, using any of a variety of bus architectures.

Memory 1108 may include various components (e.g., machine-readable media) including, but not limited to, a random access memory component, a read only component, and any combinations thereof. In one example, a basic input/output system 1116 (BIOS), including basic routines that help to transfer information between elements within computer system 1100, such as during start-up, may be stored in memory 1108. Memory 1108 may also include (e.g., stored on one or more machine-readable media) instructions (e.g., software) 1120 embodying any one or more of the aspects and/or methodologies of the present disclosure. In another example, memory 1108 may further include any number of program modules including, but not limited to, an operating system, one or more application programs, other program modules, program data, and any combinations thereof.

Computer system 1100 may also include a storage device 1124. Examples of a storage device (e.g., storage device 1124) include, but are not limited to, a hard disk drive, a magnetic disk drive, an optical disc drive in combination with an optical medium, a solid-state memory device, and any combinations thereof. Storage device 1124 may be connected to bus 1112 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1124 (or one or more components thereof) may be removably interfaced with computer system 1100 (e.g., via an external port connector (not shown)). Particularly, storage device 1124 and an associated machine-readable medium 1128 may provide nonvolatile and/or volatile storage of machine-readable instructions, data structures, program modules, and/or other data for computer system 1100. In one example, software 1120 may reside, completely or partially, within machine-readable medium 1128. In another example, software 1120 may reside, completely or partially, within processor 1104.

Computer system 1100 may also include an input device 1132. In one example, a user of computer system 1100 may enter commands and/or other information into computer system 1100 via input device 1132. Examples of an input device 1132 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1132 may be interfaced to bus 1112 via any of a variety of interfaces (not shown) including, but not limited to, a serial interface, a parallel interface, a game port, a USB interface, a FIREWIRE interface, a direct interface to bus 1112, and any combinations thereof. Input device 1132 may include a touch screen interface that may be a part of or separate from display 1136, discussed further below. Input device 1132 may be utilized as a user selection device for selecting one or more graphical representations in a graphical interface as described above.

A user may also input commands and/or other information to computer system 1100 via storage device 1124 (e.g., a removable disk drive, a flash drive, etc.) and/or network interface device 1140. A network interface device, such as network interface device 1140, may be utilized for connecting computer system 1100 to one or more of a variety of networks, such as network 1144, and one or more remote devices 1148 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1144, may employ a wired and/or a wireless mode of communication. In general, any network topology may be used. Information (e.g., data, software 1120, etc.) may be communicated to and/or from computer system 1100 via network interface device 1140.

Computer system 1100 may further include a video display adapter 1152 for communicating a displayable image to a display device, such as display device 1136. Examples of a display device include, but are not limited to, a liquid crystal display (LCD), a cathode ray tube (CRT), a plasma display, a light emitting diode (LED) display, and any combinations thereof. Display adapter 1152 and display device 1136 may be utilized in combination with processor 1104 to provide graphical representations of aspects of the present disclosure. In addition to a display device, computer system 1100 may include one or more other peripheral output devices including, but not limited to, an audio speaker, a printer, and any combinations thereof. Such peripheral output devices may be connected to bus 1112 via a peripheral interface 1156. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A computer-implemented method for training a machine learning algorithm to predict a future value of an online advertising search engine pay-per-click (PPC) keyword for a local advertising campaign, the method comprising:
continuously receiving PPC keyword performance data for the local advertising campaign as well as PPC keyword performance data for other advertising campaigns;
creating, using a computer processor, a local data model based on PPC visitors to the local advertising campaign;
creating, using a computer processor, a new training instance for the local data model for each local campaign PPC visitor,
creating, using a computer processor, a global data model based on global data model PPC visitors, the global data model PPC visitors being PPC visitors to the local advertising campaign, as well as a selected subset of PPC visitors to the other advertising campaigns where the PPC visitor's visit has a characteristic in common with the local advertising campaign;
creating, using a computer processor, a new training instance for the global data model for each global data model PPC visitor;
training, using a computer processor, a machine learning algorithm with the local data model and global data model training instances to predict a future performance of a local advertising campaign PPC keyword.

2. A method according to claim 1, wherein a value of each local data model and global data model training instance is based on visitor conversion information contained in the PPC keyword performance data.

3. A method according to claim 1, wherein the characteristic in common includes visiting another campaign as a result of selecting a same or similar keyword as a PPC keyword used by the local campaign.

4. A method according to claim 1, further comprising creating a global brand model for a brand advertised by the local campaign, the global brand model based on all PPC visitors to the local advertising campaign, as well as all PPC visitors to other advertising campaigns advertising a brand also advertised by the local campaign.

5. A method according to claim 4, wherein the creating a global brand model includes creating a separate global brand model for each brand advertised by the local advertising campaign and each brand advertised by the other advertising campaigns, wherein training instances for each brand model include all PPC visitors to any campaign that advertises the brand the brand model is designed to predict PPC keyword performance for.

6. A method according to claim 1, wherein at least one of the local and global data model training instances include at least one feature, the at least one feature including the full text of the PPC keyword.

7. A method according to claim 6, wherein the at least one feature further includes a keyword node id and a keyword parent node id associated with a domain-specific taxonomy.

8. A method according to claim 7, wherein the domain-specific taxonomy is a hierarchical structure with node ids for categorizing products within a given domain, wherein each of the PPC keywords are associated with at least one of the node ids.

9. A method according to claim 7, wherein the at least one feature further includes keyword text unique words and a match type associated with the PPC visitor a training instance is based on.

10. A method according to claim 1, wherein the training step includes inputting the local data model and global data model training instances into a supervised binary classifier machine learning algorithm to train binary classifiers used to calculate a maximum bid for a PPC keyword.

11. A bid calculation system for determining pay-per-click (PPC) keyword bids for a plurality of advertising campaigns, comprising:
a keyword database for storing all PPC keywords for all of the plurality of advertising campaigns;
a performance database for storing PPC keyword performance data for all of the plurality of advertising campaigns; and
a keyword bid calculation engine including a non-transitory computer-readable medium with instructions stored thereon, that when executed by a processor, perform the steps including:
creating local campaign model training instances for each of the plurality of campaigns based on PPC keyword performance data associated with PPC visitors to the corresponding respective local campaign;
creating global model training instances for each of the plurality of campaigns based on PPC keyword performance data associated with PPC visitors to the corresponding respective advertising campaign, as well as a selected subset of PPC visitors to other ones of the plurality of advertising campaigns where the PPC visitor's visit has a characteristic in common with the local advertising campaign;
computing a local classifier for each local campaign with the local model training instances;
computing at least one global classifier for each local campaign with the global model training instances; and
computing a base bid for each keyword for each local campaign with the local and global classifiers.

12. A bid calculation system to claim 11, wherein a value of each local data model and global data model training instance is based on visitor conversion information contained in the PPC keyword performance data.

13. A bid calculation system to claim 11, wherein the characteristic in common includes visiting another campaign as a result of selecting a same or similar keyword as a PPC keyword used by the local campaign.

14. A bid calculation system to claim 11, wherein the characteristic in common includes visiting another campaign within the same geographic area as the local campaign, or visiting another campaign focusing on a similar market segment as a market segment focused on by the local campaign.

15. A bid calculation system according to claim 11, wherein the bid calculation system further comprises a configuration database for storing a domain-specific taxonomy for categorizing products sold by the plurality of campaigns and a keywords-nodes list for linking each PPC keyword stored in the keyword database to unique node ids and associated parent node ids in the domain taxonomy, wherein the creating local and global campaign model training instances each include creating a feature for the keyword-node id and a feature for the keyword node-parent node id.

16. A bid calculation system according to claim 11, wherein the instructions stored on the keyword bid calculation engine non-transitory computer-readable medium, when executed by a processor, further include:
initializing a set of bid multiplier types;
computing, based on the PPC keyword performance data, a click-to-conversion rate for a plurality of bid multiplier values;
computing bid multipliers based on the click to conversion rates;
applying the bid multipliers to the base bids.

17. A bid calculation system according to claim 16, wherein the set of bid multiplier types include at least one of geographic location, time of day, and day of week.

18. A bid calculation system according to claim 11, further comprising creating global brand model training instances based on each PPC visitor to a local campaign as well as PPC visitors to other ones of the plurality of campaigns advertising a brand also advertised by the local campaign.

19. A bid calculation system according to claim 18, wherein the computing at least one global classifier includes computing, for each campaign, a global brand model classifier for each brand sold by the campaign using the global brand model training instances.
